(19) United States
(12) Patent Application Publication
(10) Pub. No.: US 2008/0317437 A1
(43) Pub. Date: Dec. 25, 2008

(54) INFORMATION RECORDING/REPRODUCING APPARATUS

(75) Inventor: Haruki MATONO, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/104,769

(22) Filed: Apr. 17, 2008

(30) Foreign Application Priority Data
Jun. 19, 2007 (JP) 2007-161242

(51) Int. Cl. H04N 5/907

(52) U.S. Cl. 386/96

(57) ABSTRACT

When recording data are saved and then deleted from a local storage medium to secure recordable time in a video camera, scenes of the data cannot be reproduced if network environment or a recording medium does not exist, in addition, if saved recording data are not deleted from the local storage medium, a free space is not increased, consequently a recording opportunity is missed. During backup, a saving list is created in an incorporated magnetic disk drive, and a recordable time calculation section calculates, from the saving list, data capacity of data that have been backed up in data recorded in the magnetic disk drive, and reflects the data capacity to recordable time. During recording, when a non-recorded area is exhausted, a scene in the saving list is overwritten. During reproducing, data in the saving list are reproduced from the magnetic disk drive without being connected to a network.

### CLAIM OF PRIORITY

The present application claims priority from Japanese application serial no. P2007-161242, filed on Jun. 19, 2007, the content of which is hereby incorporated by reference into this application.

### BACKGROUND

The present invention relates to an information recording apparatus, and particularly relates to a device in the information recording apparatus, which performs control of recording and saving of image/voice data and management of recordable time.

As a background art of this technical field, for example, JP-A-2004-194130 describes, as a problem, that only a certain time or only a certain capacity of images have been able to be recorded into one medium, and describes, as means for resolution thereof, that a video camera includes a local storage device, and a network connection circuit, and the network connection circuit is used for data communication to/from an external network connection device, so that an image data is transmitted to network terminal equipment at a server side, and the image data that have been transmitted are partially or wholly erased from the storage device to record only access information to the image data on the network terminal equipment.

Moreover, JP-A-2000-172596 describes a personal computer having recording and storing functions of image data, which includes a saving section and a storage server, and displays recordable time.

### SUMMARY

Recording capacity of a storage medium (local storage medium) incorporated in a video camera body is limited. Therefore, it is necessary to perform operation that data to be desirably stored are copied into an external medium, and the data are deleted from the local storage medium, thereby a free space of the local storage medium is secured. Since saving operation is a complicated work, convenience is made by a function of automatically saving data via a network as in the related art.

However, when recording data that have been saved are deleted from a local storage medium, scenes of the data cannot be reproduced or dubbed if network environment does not exist.

Conversely, if the recording data that have been saved are not deleted from a local storage medium, a free space is not increased, consequently a recording opportunity is missed.

Furthermore, when stop of saving operation and other operation such as recording are repeatedly performed, management of saved data and unsaved data becomes complicated, consequently recordable time, for example, available minutes of time left for recording, becomes unclear in the hour of need.

Thus, in the light of the above, a first object of the invention is to provide a module to inform recordable time in consideration of presence of data saving to a user.

A second object of the invention is to provide a module which enables reproducing or dubbing without network environment even after saving operation when a local storage medium has a sufficient free space.

To summarize the invention, to achieve the objects, a module is provided, which informs recordable time being added with time of saving data to a user, and a module is provided, which deletes the saving data only in the case that a non-recorded area is exhausted.

Moreover, when saving data still exist in a local storage medium during reproducing or dubbing, reproducing or dubbing is performed from the local storage medium without network environment.

In detail, to achieve the objects, an information recording apparatus of the invention includes a recording section for recording image/voice data, a saving section for saving copy data of the image/voice data to the outside while leaving the image/voice data recorded in the recording section, and a saving data storage section for holding, as saving information, information of the image/voice data saved from the recording section; wherein remained recordable time, in which the image/voice data can be recorded into the recording section, is calculated using the saving information held by the saving data storage section.

According to the invention, appropriate recording operation and reproducing operation can be achieved.

### BRIEF DESCRIPTION OF THE DRAWINGS

These and other features, objects and advantages of the present invention will become more apparent from the following description when taken in conjunction with the accompanying drawings wherein:

FIG. 1 shows a block diagram of a general configuration of an information recording apparatus in an embodiment;

FIG. 2 shows a schematic diagram showing an example of a format of stored data as saving list in the embodiment;

FIG. 3 shows a flowchart of operation during backup of a recordable time control section in the embodiment;

FIG. 4 shows a flowchart of operation during recording of the recordable time control section in the embodiment;

FIG. 5 shows an explanatory diagram in the case that a backup control unit is specified as one scene in the embodiment; and

FIG. 6 shows an explanatory diagram in the case that a backup control unit is specified as one second in the embodiment.

### DETAILED DESCRIPTION OF PREFERRED EMBODIMENTS

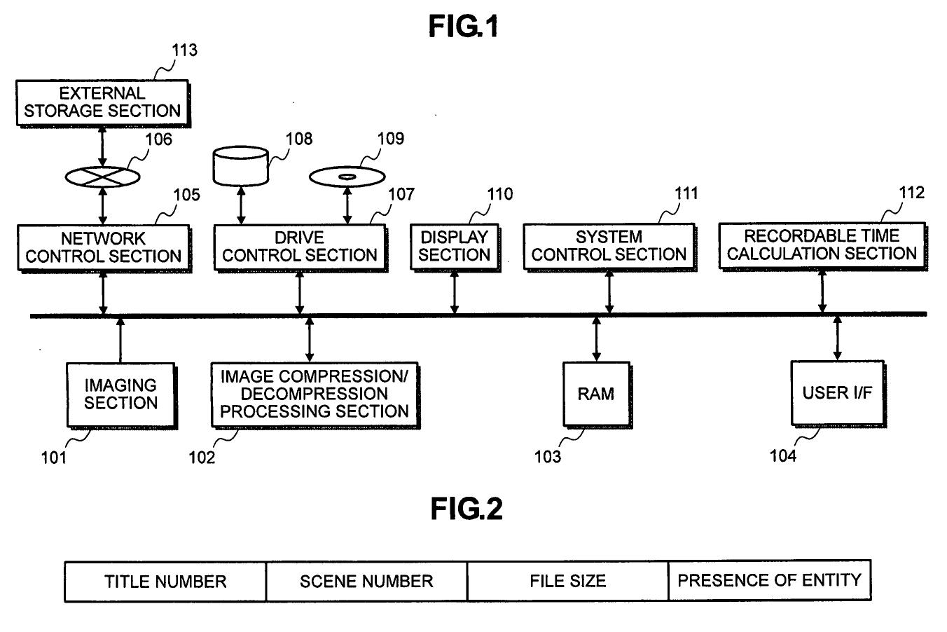

Hereinafter, preferred embodiments of the invention are described in detail with reference to drawings. FIG. 1 shows a diagram showing an example of a video camera as an information recording/reproducing apparatus according to the invention. The invention is not limited to the video camera, and can be applied to any equipment for storing image/voice data such as a recorder including DCD recorder, and is not limited to particular equipment.

FIG. 1 shows a block diagram showing a system configuration of a video camera using a network, according to example 1 of the invention.

An imaging section 101 loads an image (including voice), and generates first image data. An image compression/decompression section 102 converts the first image data into second image data according to a predetermined image data format, and inverts the second image data into the first image data. RAM 103 performs temporary storage holding of data. User I/F 104 receives a command from a user.

A network control section 105 performs data communication with respect to an external storage section 113 via a network 106. A drive control section 107 performs controls a magnetic disk drive 108 and an optical disk drive 109 as a large-capacity recording medium respectively. A display section 110 performs display of the first image data, display of first data given by inverting the second image data, or various types of information display. A system control section 111 performs control of respective blocks shown in FIG. 1. A recordable time control section 112 performs control for displaying recordable time on the display section 110.

Specific operation of the video camera is described.

The imaging section 101 loads an image and generates first image data, and sends the data to the image compression/decompression section 102 and the display section 110. The display section 110 includes a view finder or a liquid crystal panel, by which a user confirms an image being currently taken by a user. The display section 110 is used as a module to reproduce a taken image later.

The image compression/decompression section 102 is a compression/decoding circuit of image data, and for example, performs MPEG (Moving Picture Expert Group) compression on a first image data to be into a second image data, or decodes the second image data into the first image data. Since the amount of the first image data outputted by the imaging section 101 is enormous, the data are converted into the second image data by the image compression/decompression section 102. The second image data are recorded into the magnetic disk drive 108 or the optical disk drive 109 via the drive control section 107. The image compression/decompression section 102 compresses an image during photography, and decodes an image during reproducing the image. Such change between compression and decoding is performed according to control by the system control section 111. During reproducing, the first image data decoded by the image compression/decompression section 102 are sent to the display section 110 so as to be displayed.

The RAM 103 is used as a buffer when image data are transferred to each block. Moreover, it is also used as an information transmission module between respective blocks.

The user I/F 104 receives a recording start/stop command or various kinds of operation from a user. The user I/F includes input from a button and input from a liquid crystal touch panel.

The network control section 105 performs control of transmission/reception of data to/from the external storage section 113 via the network 106. In the case of wired communication, communication can be made by an Ethnet (registered trademark) method, and in the case of wireless communication, it can be made by a method of IEEE-802.11g or IEEE-802.11b. Moreover, a mobile phone may be controlled to be used for a communication module. That is, a communication module is not particularly limited.

The network 106 includes LAN or Internet. While only the camera and external storage section 113 were described as devices and the like to be connected to the network here, a number of devices are typically connected to the network, and the camera can be connected to a desired device by the network control section 105. The external storage section 113 includes a hard disk incorporated in a personal computer of individuals, and a storage using disk hosting service provided on Internet.

The drive control section 107 is connected with the magnetic disk drive 108 and the optical disk drive 109 as a large capacity drive respectively, so that controls the drives. A user previously sets, using the user I/F 104, one of the magnetic disk drive 108 and the optical disk drive 109 as a drive to be recorded with data, and based on a result of such user setting, the drive control section starts a directed device, and performs control of recording operation.

The first image data acquired by the imaging section 101 are inputted into the image compression/decompression section 102 via the RAM 103. The image compression/decompression section 102 compresses the first image data into the second image data. The compressed, second data are inputted into the drive control section 107 via the RAM 103. The second image data to be inputted are recorded into the magnetic disk drive 108 or the optical disk drive 109, which is directed by a user. Conversely, during reproducing, the second image data are read from the magnetic disk drive 108 or the optical disk drive 109, and restored into the first data by the image compression/decompression section 102 via the RAM 103. The restored first data are inputted into the display section 110.

In addition to the reproducing/recording operation, operation of data saving called backup is given. In this operation, data within a camera body are transferred into an external storage section. Image data read from the magnetic disk drive 108 or the optical disk drive 109 are transferred into the external storage section by the network control section 105.

Here, while drives connected to the drive control section 107 are described to be the magnetic disk drive 108 and the optical disk drive 109, the invention is not limited to these, and the number of drives is not limited to two. A semiconductor memory can be used in place of the magnetic disk drive 108 or the optical disk drive 109.

The display section 110 is provided to display the first image data acquired through the imaging section 101, to display a photographing condition or an operation condition of a camera according to an instruction from the system control section 111, and to display recordable time given from the recordable time control section 112. A user takes a photograph of contents to be recorded while confirming display on the display section 110, and understands a condition of the camera from display on the display section 110.

The system control section 111 controls respective blocks as shown in FIG. 1. For example, during recording, the section 111 performs control of giving a first image data generation instruction to the imaging section, giving a display instruction of the image data to the display section 110, giving a compression start instruction to the image compression/decompression section 102, and giving a recording start instruction to the drive control section.

The recordable time control section 112 has the following three functions.

A first function is monitoring whether the relevant scene is backed up in backup operation, and storing the backed-up scene as a saving list into the magnetic disk drive 108 via a disk control section.

FIG. 2 shows an example of contents to be stored as a saving list. The saving list is configured by four items of a title number, a scene number, file size, and presence of entity. The title number and the scene number are management numbers respectively, and when the two are specified, a scene can be specified. The file size is used for calculation of estimating a level of increase in free space by deleting the scene. The presence of entity shows whether the scene has been deleted from the magnetic disk drive 108 or not.

A second function of the recordable time control section 112 is, rather than displaying the remaining amount of the magnetic disk drive 108 or the optical disk drive 109, summing file sizes having the entity in the saving list, and displaying the sum with being added to the remaining amount. That is, the list is created during backup as the first function, and to a query on a free space from a user, the data that have been backed up are informed to the user as a recordable area.

That is, data are divided into three areas of an area being recorded and backed up, an area being recorded and not backed up, and an area being unrecorded. In the related arts, the unrecorded area is informed as the remaining amount, but in the invention, the above two areas are informed as the remaining amount. A third function of the recordable time control section 112 is automatically deleting the area being recorded and not backed up for each scene when the unrecorded area is exhausted.

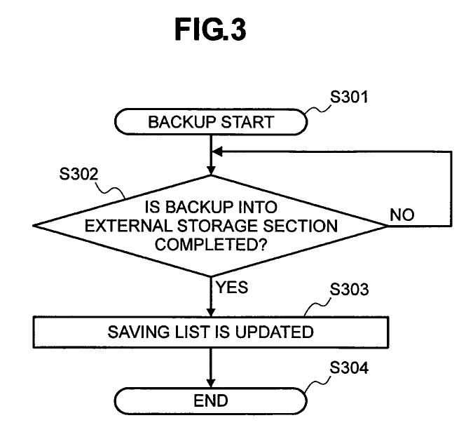

FIG. 3 shows an operation flow during backup of the recordable time control section 112.

After backup processing is started in step 301, image/voice data that have been recorded are transferred from the magnetic disk drive 108 to the external storage section 113 via the network 106. The recordable time control section 112 monitors completion of such transfer (step 302).

When the transfer is completed, a saving list is updated in step 303. An example of the saving list is shown in FIG. 2, and as described before, the list includes the title number, scene number, file size, and presence of entity. A title number and scene number being currently backed up are stored. The numbers are acquired from the magnetic disk drive 108 or the optical disk drive 109 when the system control section 111 is started. For example, a management method is given, in which the title number is counted every date, and the scene number is counted at each set of start and stop of recording. It is also acceptable that the title number is allocated to a title of a DVD video standard, and the scene number is allocated as an entry point. The backup processing is finished in step 304.

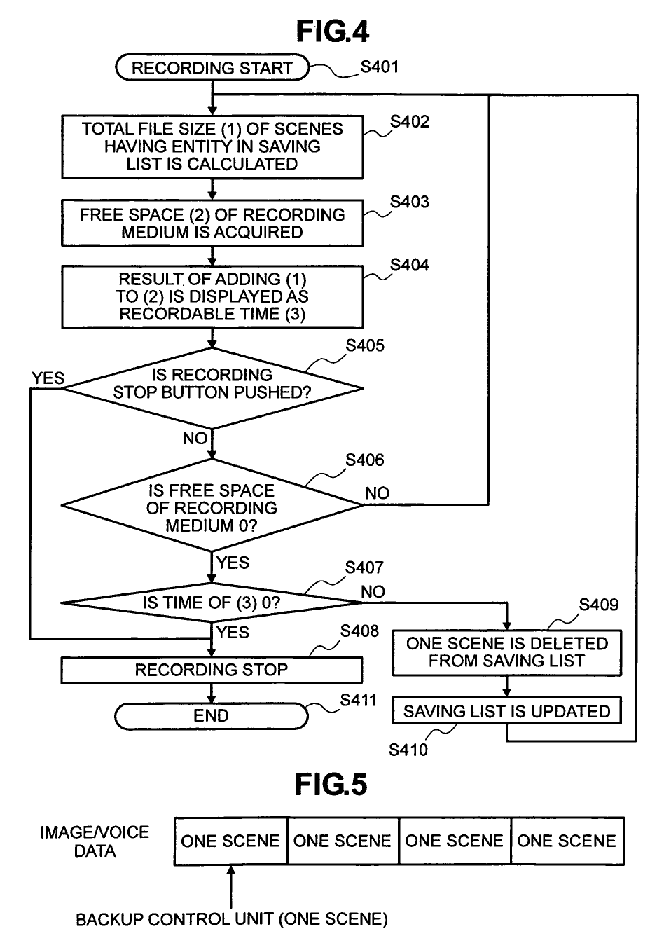

FIG. 4 shows an operation flow during recording of the recordable time control section 112.

Recording is started in step 401. From step 402 to step 404, recordable time to be displayed is calculated, and displayed on the display section 110. In step 405, whether a user pushed a recording stop button or not is determined, and when the button is pushed, processing is shifted to step 408, and when it is not pushed, that is, when recording is to be continued, processing is shifted to step 406.

In step 406, whether a free space of recording medium, namely, a free space of each of the magnetic disk drive 108 and the optical disk drive 109 is zero or not is determined. When the free space is zero, the processing is shifted to step 407, and when the free space is not zero (when the remaining amount exists), the processing is returned to the step 402. Here, determination maybe made with a certain threshold value, rather than determining whether the remaining amount is zero or not. A certain threshold value is generally set for a system to allow some margin. In step 407, whether the recordable time is zero or not is determined, the recordable time being calculated from a size obtained by adding the sum total of the file sizes having entity in the saving list to the free space of the recording medium. When the recordable time is zero, processing is advanced to step 408, and when it is not zero, processing is advanced to step 409. A certain threshold value may be used for determination, rather than using zero for determination, similarly as above.

In step 409, one scene is selected from the saving list, and the scene is deleted in entity from the magnetic disk drive 108 or the optical disk drive 109. A deletion object is determined from the saving list by an optional process. As an example, a method is given, in which an item of recording date of a scene is added to the saving list, and scenes are deleted in order from a scene having an older recording date. Alternatively, a method is given, in which an item of weighted information is added to the saving list such that a user can perform weighing, and scenes are deleted in order from a scene being less weighed. Step 410 is an update processing step of the saving list. A scene of which the entity has been deleted is deleted from the list. Here, the scene of which the entity has been deleted may not been deleted from the saving list, and may be managed by using a deletion mark. In this case, when a scene that has been deleted is instructed to be reproduced, image/voice data of the scene are received via the network 106, so that the scene can be reproduced. In the step 408, recording stop processing is instructed to the system control section 111.

Finally backup is described. When the system does not perform each of recording and reproducing, or while not shown in detail here, when the system is operated with being applied with an external power supply, the system control section 111 automatically starts backup processing. By the backup processing, image/voice data that have been recorded are transferred from the magnetic disk drive 108 to the external storage section 113 via the network 106. A condition of backup start timing is optionally set, and while it was described as an example in the above that backup was started when the system did not perform each of recording and reproducing, or when the system was applied with the external power supply, backup may be started when the network control section 105 detects possibility of connection to the network 106, and the invention does not limit the condition. Moreover, backup may be performed without using the network 106, but may be performed using other communication module such as a USB interface.

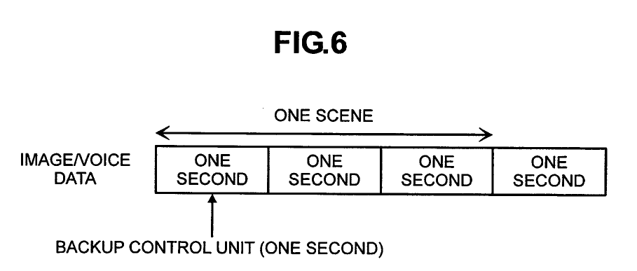

FIGS. 5 and 6 are explanatory diagrams of a unit of transfer control during backup. When data are transferred, the transfer may be performed by one scene as in FIG. 5, or may be performed more finely with a scene being divided every one second as in FIG. 6. While the invention does not refer to a unit of transfer control in detail, in the case that the transfer control is performed in a unit other than the scene as in FIG. 6, when the saving list is allowed to have a flag showing whether transfer of the relevant scene is completed, it is useful for next backup processing. If the control is performed in a fine unit, when backup is stopped and restarted, a transfer restart point can be finely controlled, therefore transfer time can be reduced. That is, backup can be restarted form a point being immediately close to a point at which transfer is stopped.

Specific operation of the camera is described.

Photography is performed as in a typical video camera. It is assumed that the magnetic disk drive 108 was used as a recording medium. It is assumed that the photography is generally completed, and the camera is connected to an external power supply. At that time, it is assumed that four scenes are photographed every five minutes in the camera, and a free space of the magnetic disk drive 108 is 40 min. Then, the camera is automatically connected to the previously set, network 106, and backup of image/voice data into the external storage section 113 is started.

At timing when backup of the third scene is finished, the remaining amount is confirmed, and 55 min is displayed on the display section 110. Next, when scenes are attempted to be reproduced, all four scenes for 20 min that have been photographed can be reproduced. Here, recording is started, and one scene for 50 min is photographed as a fifth scene. Here, when scenes are attempted to be reproduced, the third scene for 5 min, the fourth scene for 5 min, and the fifth scene for 50 min can be reproduced. Here, it should be noticed that the first and second scenes have been backed up, they are automatically deleted, and that data can be recorded for 50 min.

In the example of the invention, while recording data are not immediately deleted after data saving, since recordable time is informed to a user while being added with time of recording data that have been saved, the user can exactly know available minutes of time left for recording.

Moreover, when a non-recorded area of the local storage medium is exhausted, since saved data are deleted, recording opportunities can be secured.

Furthermore, the data that have been saved can be reproduced as long as a local storage medium exists, even if network environment does not exist.

As described hereinbefore, when the camera is used, data can be backed up into an external storage device on a network without backup operation by a user, and the backed-up data are displayed as a free space on the camera, therefore available minutes of time left for recording can be understood. Data that have been backed up are sequentially overwritten. Moreover, when recording is not performed, image/voice data being backed up can be reproduced without network connection. In this way, while backup is performed, a storage area of a video camera can be effectively used. Furthermore, since data being backed up and data being not backed up are managed by the camera, a waste that the same image/voice data are doubly stored in a backup device and a body can be eliminated.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An information recording apparatus, comprising:
a recording section for recording image/voice data,
a saving section for saving copy data of the image/voice data to the outside while leaving the image/voice data recorded in the recording section, and
a saving data storage section for holding, as saving information, information of the image/voice data saved from the recording section;
wherein remained, recordable time, in which the image/voice data can be recorded into the recording section, is calculated using the saving information held by the saving data storage section.

2. The information recording apparatus according to claim 1, further comprising:
a display section for displaying the remained recordable time.

3. The information recording apparatus according to claim 1, further comprising:
a deletion section for deleting the left image/voice data according to the saving information in the case that a recordable area in the recording section is exhausted.

4. The information recording apparatus according to claim 1:
wherein the saving section saves the image/voice data to the outside in a unit given by segmentalizing one scene of the image/voice data.

5. The information recording apparatus according to claim 1:
wherein the saving section saves data to an external storage device using a wireless or wired communication module.

6. The information recording apparatus according to claim 1, further comprising:
an external data acquisition section for acquiring image/voice data from the outside, and
a reproducing section for reproducing the image/voice data from the recording section if the saved image/voice data are not deleted from the recording section.
